(19) United States
(12) Patent Application Publication
(10) Pub. No.: US 2003/0092429 A1
(43) Pub. Date: May 15, 2003

(54) Method of transferring facility information by radio and control center

(75) Inventors: Kuo-Rong Chen, Panchiao City (TW); Chun-Chung Lee, Taipei (TW); Cheng-Hung Huang, Miaoli Hsien (TW)

Correspondence Address: BACON & THOMAS, PLLC, 625 SLATERS LANE, FOURTH FLOOR, ALEXANDRIA, VA, 22314

(73) Assignee: Sin Etke Technology Co., Ltd., Taipei (TW)

(21) Appl. No.: 10/087,841

(22) Filed: Mar. 5, 2002

(30) Foreign Application Priority Data
Nov. 9, 2001 (TW) 90127953

(51) Int. Cl. H04Q 7/20

(52) U.S. Cl. 455/414; 455/456; 701/207

(57) ABSTRACT

A method of transferring facility information by radio in which the user uses a radio communication device (for example, cellular telephone) to connect to a control center through a base station, requesting the control center to transfer the information of facilities in the area around the location of the radio communication device. The computer system of the control center has a facility information database from which the control center searches the desired facility information subject to the target of the location of the base station or the location of the radio communication device.

### BACKGROUND OF THE INVENTION

1. Field of the Invention

The present invention relates to a method of transferring facility information by radio and a control center and, more particularly, to the use of a base station for a signal transfers service during the process of radio signal transmission.

2. Description of Related Art

Conventionally, when wishing to find the location of a particular nearby facility, for example, the location of a nearby parking lot, one may use a map or connect to the Internet to use an electronic map. Much attention must be paid when searching a map for the location of the facility due to the maps small size, resulting in an extended search time. Further, before searching the map, the user needs to know the current location so as to correspond the current location to the page number of the conventional map used or the relative position in the electronic map used.

According to conventional methods, two steps are involved when searching for the location of a particular nearby facility. . The first step is to find the map corresponding to the current location. The second step is to search the selected map for the location of the desired facility. The two-step process is quite time consuming. And, if the user does not know his (her) location he (she) cannot proceed to the second step.

Therefore, it is desirable to provide a method of transferring facility information by radio and a control center that enables the user to rapidly search for the location of a particular nearby facility when the user does not know his (her) current location.

### SUMMARY OF THE INVENTION

The main object of the present invention is to enable users to find the location of a particular nearby facility using a quick and easy method. For example: a parking lot, gas station, police station, hospital, etc. It is another object of the present invention to provide a control center using a method of transferring facility information by radio, which allows the user to quickly find the location of a particular nearby facility based on the location and the information provided by a nearby base station when the user does not know his (her) current location.

To achieve these and other objects of the present invention, a control center is provided for enabling the user to obtain the desired information through a radio communications device (for example, cellular telephone) via a nearby base station. The control center comprises a communication system adapted to receive messages from the outside and to transmit messages to the outside; and a computer system connected to the communication system. The computer system comprises a facility information database. The control center uses the information of the location of the nearby base station or the information of the location of the radio communications device (in case the radio communication device is equipped with a Global Positioning System) as the target, and then searches a facility information database for the desired facility information subject to the targets location. The facility information database has stored the names, locations and other important data of multiple facilities. Therefore, if the user does not know his (her) current location, the control center can still search for the location, or other relevant information, of the desired nearby facilities from the database based on the target. For example: the location and significant information of available parking lots within a 5 kilometer radius of a nearby base station (target), and then providing the location of available parking lots to the radio communications device.

Other objects, advantages, and novel features of the invention will become more apparent from the following detailed description when taken in conjunction with the accompanying drawings.

### BRIEF DESCRIPTION OF THE DRAWINGS

FIG. 1 illustrates the environment in which the invention is used.

FIG. 2 illustrates the structural design of the control center according to the present invention.

FIG. 3 is a functional block diagram of a first embodiment of the radio communications device according to the present invention.

FIG. 4 illustrates an embodiment of the facility information database according to the present invention.

FIG. 5 is an operation flow chart of the first embodiment of the present invention.

FIG. 6 is an operation flow chart of the second embodiment of the present invention.

FIG. 7 is an operation flow chart of the third embodiment of the present invention.

FIG. 8 is an operation flow chart of the fourth embodiment of the present invention.

FIG. 9 is an operation flow chart of the fifth embodiment of the present invention.

FIG. 10 is an operation flow chart of the sixth embodiment of the present invention.

FIG. 11 is a functional block diagram of a second embodiment of the radio communication device according to the present invention.

### DETAILED DESCRIPTION OF THE PREFERRED EMBODIMENTS

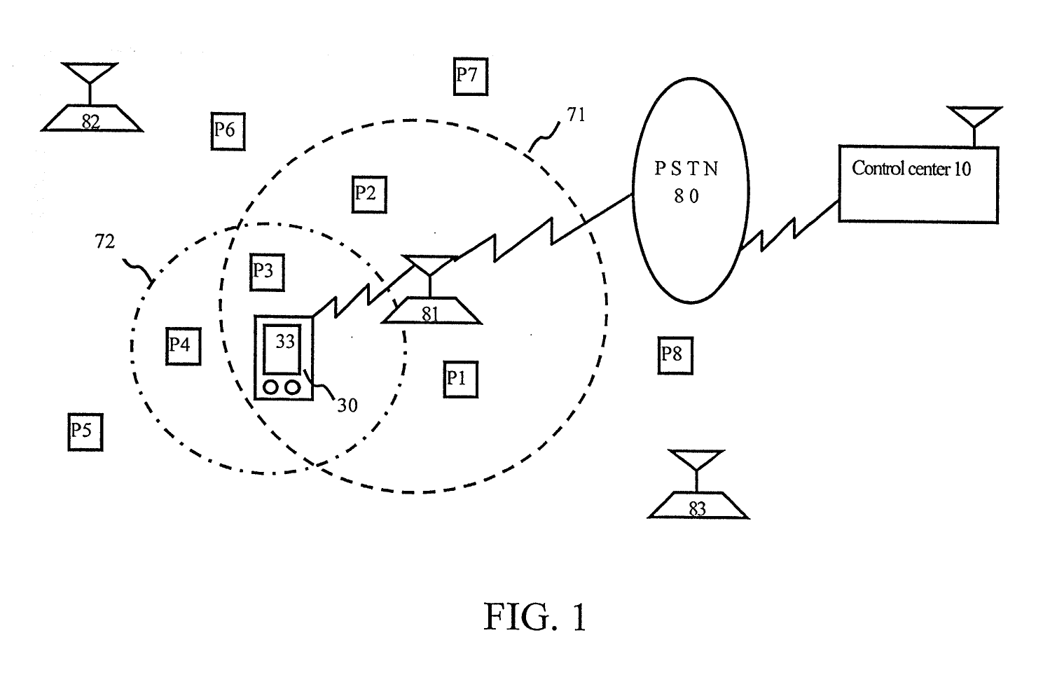

FIG. 1 illustrates the environment in which the invention is used. As illustrated, the present invention provides a control center 10, which enables users to obtain information through a radio communication device 30 (for example, a cellular telephone). In order to ensure reliable quality communication in a big area with radio communication architecture, multiple base stations 81˜83 are available. When transmitting or receiving a message through the radio communication device 30, the base station nearest to the radio communication device 30 controls and services the transferring of the message. For example, the nearest base station 81 provides the service of transferring the message. Finally, base station 81 transfers the message to the control center 10 through a PSTN (Public Switching Telephone Network) 80.

When wishing to get particular information with the radio communication device 30. Such as the locations of nearby parking lots, the invention provides two searching methods. For example, there are eight parking lots P1˜P8 shown in FIG. 1, with the information being stored in the control center 10. The first search method uses base station 81, which is nearest to the radio communication device 30 to provide information of parking lots around base station 81. For example, the location information of the parking lots P1, P2, and P3 in the surrounding area 71 within 5 kilometers of base station 81. The second search method uses radio communication device 30 to provide the information of parking lots around the radio communication device 30, for example, the information of the parking lots P3 and P4 in the surrounding area 72 within 3 kilometers from the radio communication device 30. When the second searching method is adopted, the radio communication device 30 must be able to provide its location information.

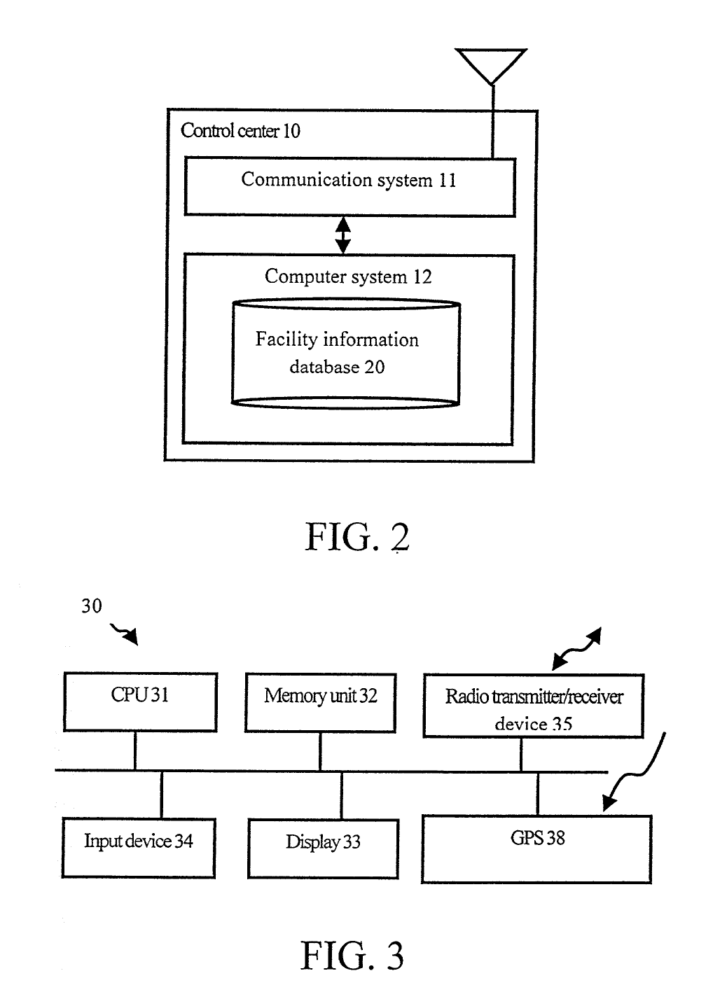

Referring to FIG. 2, the control center 10 comprises a communication system 11 adapted to receive messages from or transmit messages to the outside (for example, the PSTN 80) either by cable or radio, and a computer system 12 connected to the communication system 11 adapted to run the requisite software program. According to the present invention, the computer system 12 comprises a facility information database 20.

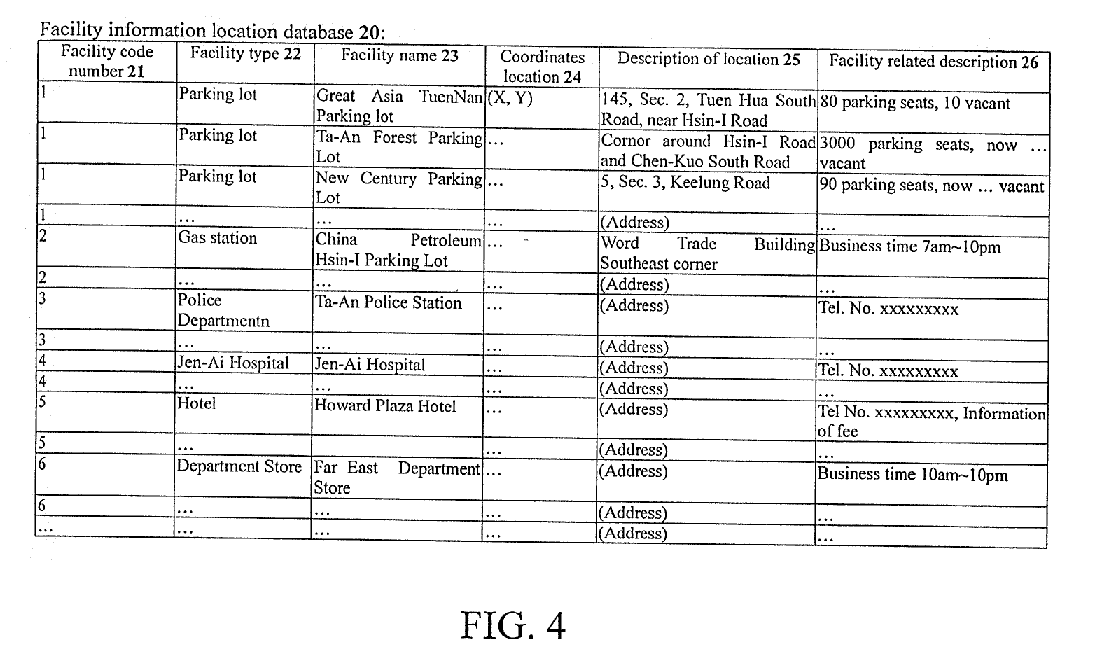

FIG. 4 illustrates an embodiment of the facility information database 20. According to this embodiment, the facility information database 20 includes columns for facility code number 21, facility type 22, facility name 23, location coordinates 24, description of location 25, and relevant facility descriptions 26. In actual practice, facilities of the same type have the same facility code number 21, for example, the facility code number 21 is 1 for parking lots, or 3 for police stations. Facility name 23 lists the names of the respective facility, for example, Great Asia Tuen-Nan Parking Lot, Ta-An Forest Parking Lot, etc. Location coordinates 24 can be a coordinate system set by the user, or the longitude and latitude coordinates of the GPS (Global Positioning System). Location coordinates 24 can also be a location code number that indicates the (precise or general) location of a particular facility. Description of location 25 can be the address of the respective facility, or a particular landmark. Relevant facility description 26 describes the information of the respective facility the user may wish to know. For example, if facility type 22 is a parking lot, relevant facility description 26 could be the total number of parking spaces, the number of vacant parking spaces, the parking fee, etc. If facility type 22 is a gas station, facility related description 26 could provide the working hours of the respective gas station. It is to be understood that the information content of relevant facility description 26, for example, the information of the number of vacant parking seats may be changed frequently. Therefore, the control center 10 must monitor the parking lot (through the Internet or a fixed cable).

FIG. 3 is a functional block diagram of one embodiment of the radio communication device 30. The radio communication device 30 can be a cellular telephone (either connectable or not connectable to the Internet), a PDA (Personal Data Assistant) with radio communication function, or a Laptop PC (Personal Computer) with radio communication function. As illustrated in FIG. 3, the radio communication device 30 comprises a CPU 31, a memory unit 32, a display 33, an input device 34, and a radio transmitter/receiver device 35. The memory unit 32 has stored therein particular data and software programs for the CPU 31 to run. The display 33 can be a device that displays graphics and letters. Alternatively, the display 33 can be a touch panel with input function. The input device 34 can be a keyboard, mouse, or a touch control device for a touch panel. The radio transmitter/receiver device 35 is an apparatus for transmitting and receiving radio signals. In an alternate form the radio communication device 30 of the present invention further comprises a GPS (Global Positioning System) 38 that provides the longitude and latitude coordinates of the radio communication device 30 (based on the principle of using an antenna to receive signals from three global positioning satellites and computing the current global positioning data, for example, longitude and latitude coordinates).

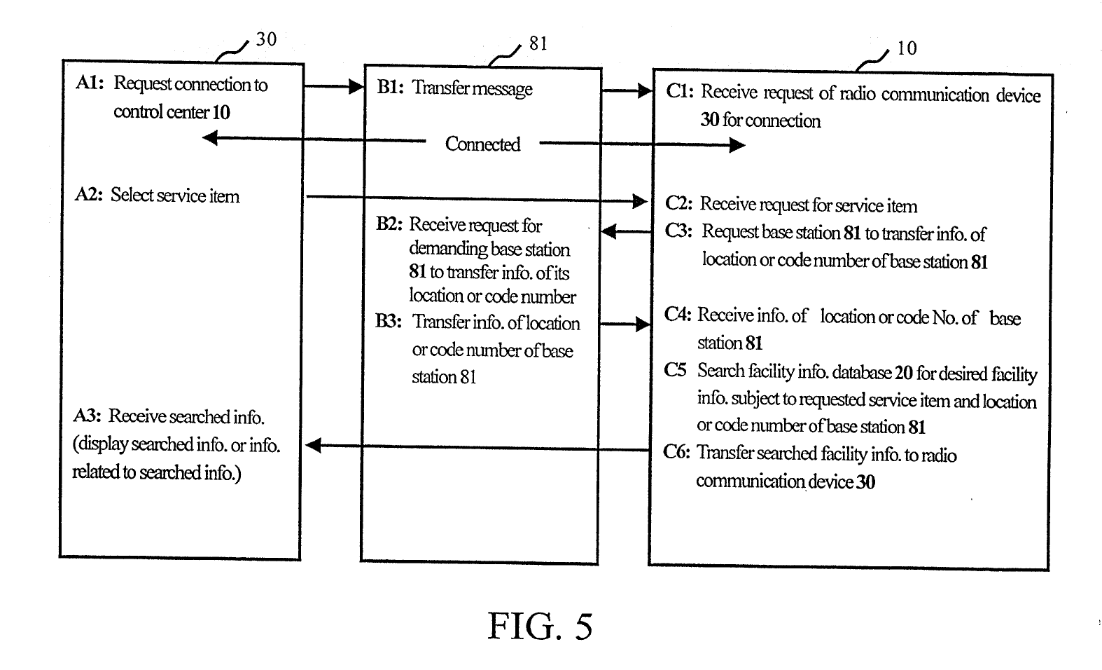

The operation of the present invention is outlined hereinafter with reference to FIGS. 5 through 9. FIG. 5 is a flow chart showing the operation of a first embodiment of the present invention. According to this embodiment, the operation of the present invention includes the following steps:

Step A1:

where the radio communication device 30 requests a connection to the control center 10; for example, the user dials a telephone number, which is the control center 10, or connects to a web site, which is the control center 10;

Step B1:

where the base station 81 transfers the message to the control center 10;

Step C1:

where the control center 10 receives the radio communication device 30 request, and the radio communication device 30 is connected to the control center 10;

Step A2:

where the user selects the service item by inputting the facility code number 21, for example, inputting 1 to search for parking lot information; the control center 10 may provide a voice service to guide the user as to what code number, character or sign to input for the desired service;

Step C2:

where the control center 10 receives the service item request;

Step C3:

where the control center 10 requests the base station 81 in charge to transfer the information of its location (location coordinates) or code number so as to know which base station is in charge of the communication with the radio communication device 30; the control center 10 immediately knows the location of the base station in charge subject to the code number if it has the information of base station code numbers and location index stored therein;

Step B2:

wherein the request of the control center 10 of demanding the base station 81 to transfer the information of its location or code number is received;

Step B3:

where the information of the location or code number of the base station 81 is transmitted;

Step C4:

where the message of the location or code number of the base station 81 is received;

Step C5:

where the facility information database 20 is searched for the required facility information subject to the requested service item and the information of the location or code number of the base station 81; for example, the service item requested by the use is the information of parking lots and the default value is to search for facilities in the area within 5 kilometers from the base station 81; the user may be requested to input the desired distance, for example, “4 kilometers”, and the information of parking lots is the parking lots in the area within 4 kilometers from the base station 81;

Step C6:

where the control center 10 transfers found facility information to the radio communication device 30; and

Step A3:

where the radio communication device 30 receives the found facility information from the control center 10, and displays the found facility information or the information related to the found facility information.

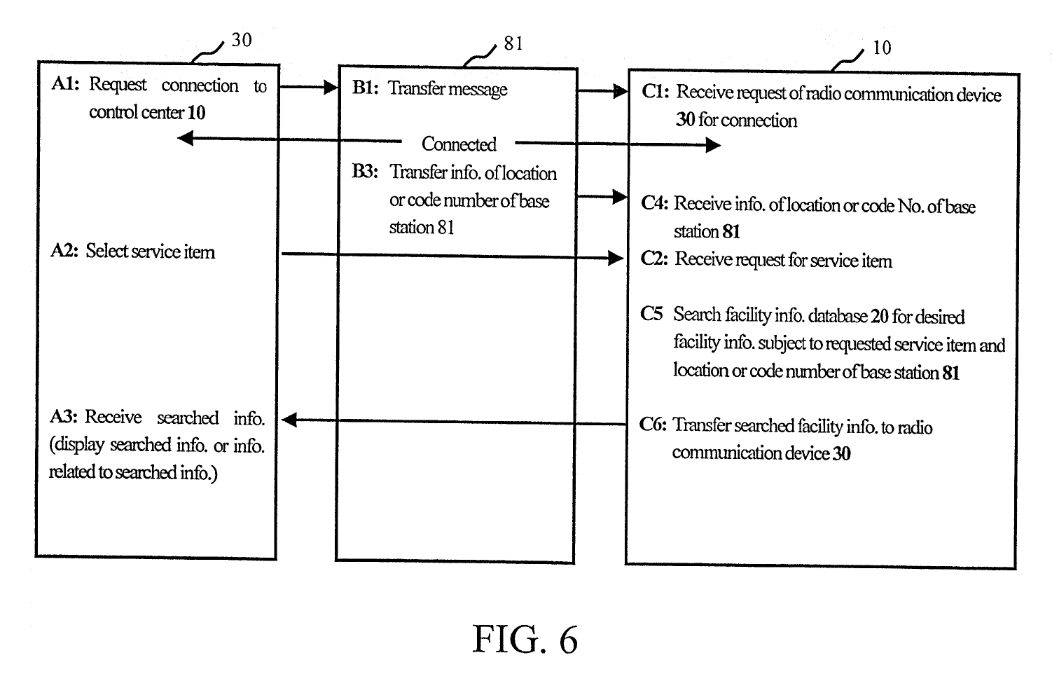

FIG. 6 is a flow chart showing the operation of a second embodiment of the present invention. According to this embodiment, the operation of the present invention includes the steps A1, B1, C1, B3, C4, A2, C2, C5, C6, and A3. With respect to the description of the related steps, please refer to the aforesaid description for FIG. 5.

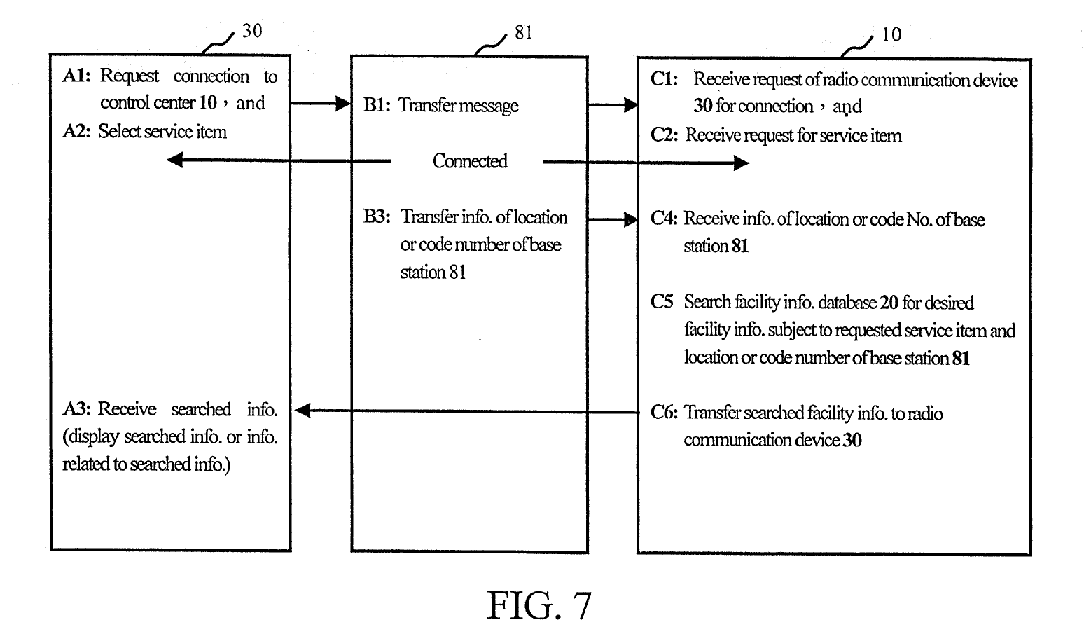

FIG. 7 is a flow chart showing the operation of a third embodiment of the present invention. According to this embodiment, steps B3 and C4 are respectively exchanged with steps A2 and C2 in comparison with the aforesaid second embodiment, i.e., step A2 and step C2 regarding service item selection are processed first, and step B3 and step C4 regarding the location or code number of base station 81 is processed later. Further, when requesting a connection to the control center 10 during step A1, the user also selects the service item. For example, when dialing a telephone number, the user also dials the facility code number 21, i.e., the format is “Telephone number-Facility code number 21”. This third embodiment can be set to proceed steps A2 and steps C2 after connection of the radio communication device 30 to the control center 10.

The order of the steps of the operation flow of the third embodiment is: A1, A2, B1, C1, C2, B3, C4, C5, C6, and then A3. With respect to the description of the related steps, please refer to the description for FIG. 5.

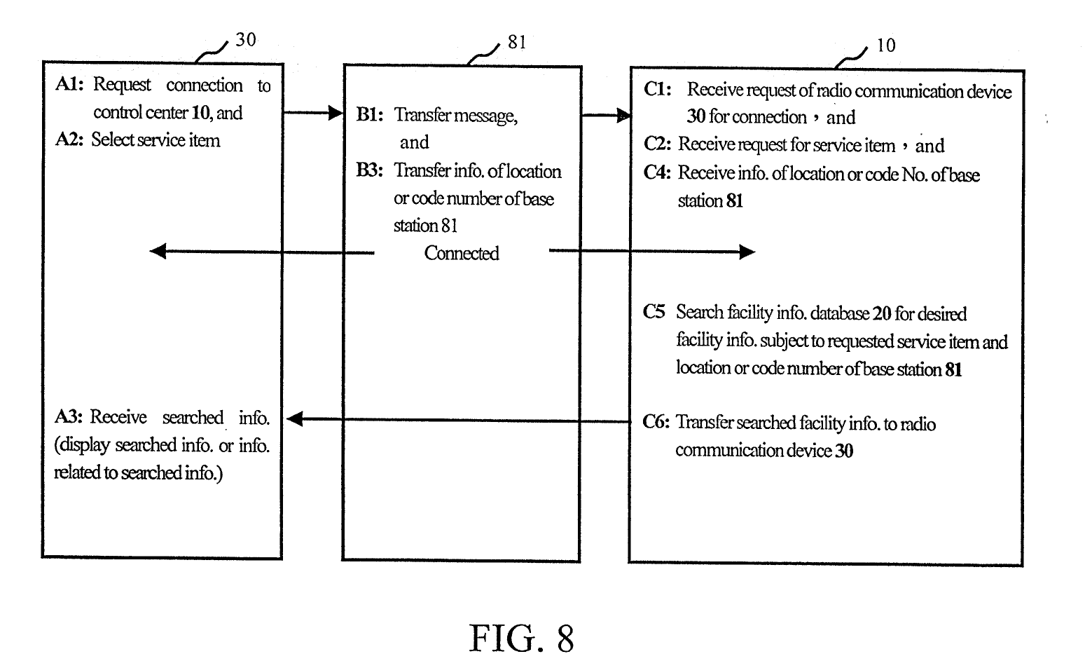

FIG. 8 is a flow chart showing the operation of a fourth embodiment of the present invention. In comparison with the aforesaid third embodiment, the fourth embodiment enables the base station 81 to run steps B1 and B3 at the same time, so that the control center 10 runs step C4 when running C1 and C2, i.e., base station 81 sends its location or code number information to the control center 10 when the radio communication device 30 requests a connection to the control center 10.

The order of the steps of the operation flow of the fourth embodiment is: Step A1, Step A2, Step B1, Step B3, Step C1, Step C2, Step C4, Step C5, Step C6, and then Step A3. With respect to the description of the related steps, please refer to the description for FIG. 5.

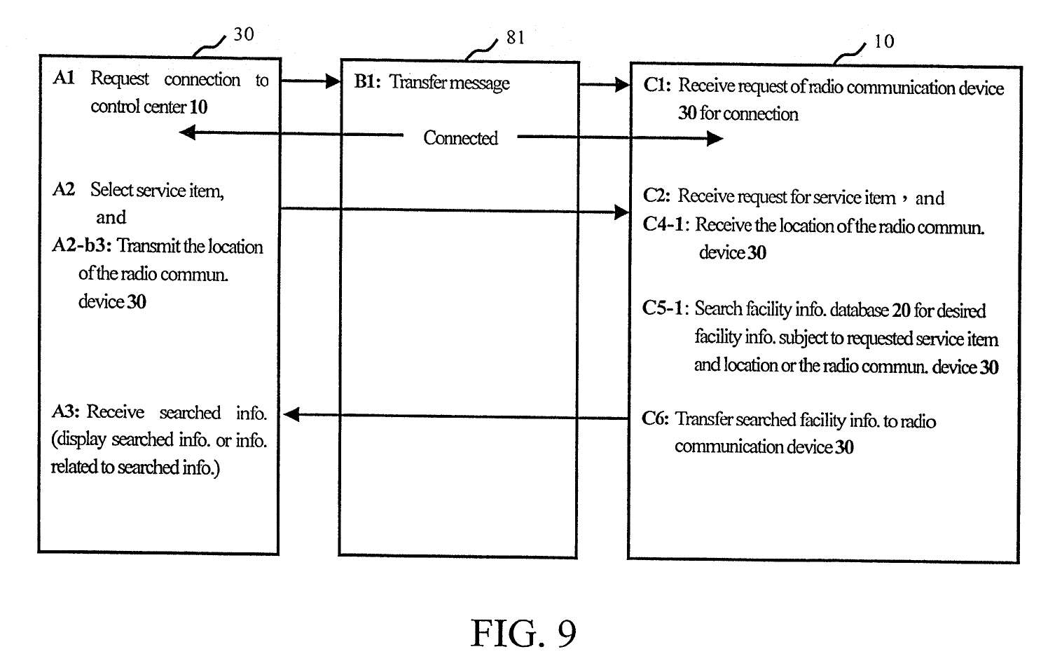

FIG. 9 is a flow chart showing the operation of a fifth embodiment of the present invention. In comparison with the aforesaid first embodiment, the radio communication device 30 of the fifth embodiment is equipped with a GPS 38, therefore the radio communication device 30 can provide the information of its location to the control center 10. According to this fifth embodiment, the operation of the present invention includes the steps of:

Step A1, Step B1, Step C1 (with respective to the aforesaid steps, please refer to the description for FIG. 5.);

Step A2:

where the user selects the service item and simultaneously proceed Step A2-1;

Step A2-b3:

where the information of the location of the radio communication device 30 is transmitted to the control center 10;

Step C2:

where the control center 10 receives the service item request, and then proceeds Step C2-1;

Step C4-1:

where the information of the location of the radio communication device 30 is received;

Step C5-1:

This step is similar to the aforesaid Step C5 but the target is the location of the radio communication device 30 but not the location of the base station 81 indicated in the aforesaid embodiments from the first through the fifth.

Step C6, and Step A3:

With respect to the description of the related steps, please refer to the description for FIG. 5. Further from the first through the fifth embodiments, Step A2-b3 may substitute for Step B3; step C4-1 may substitute for Step C4; Step C5-1 may substitute for Step C5, enabling the target to be the information of the location of the radio communication device 30.

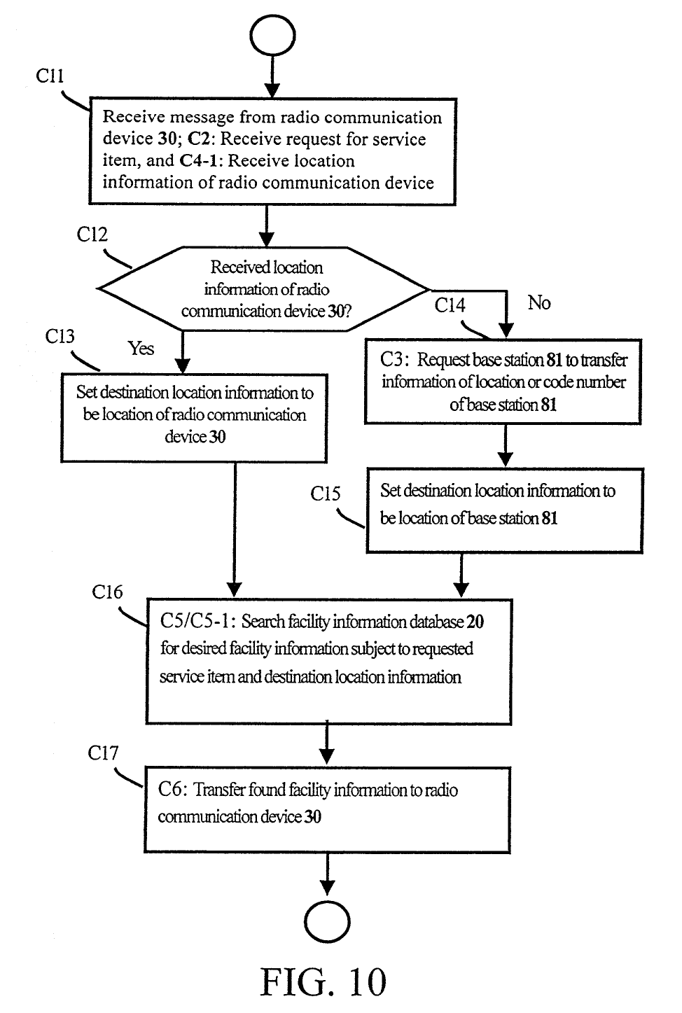

FIG. 10 is a flow chart showing the operation of a sixth embodiment of the present invention. According to this embodiment, the control center 10 proceeds a different process. If the radio communication device 30 provides the its location information, the target in the sixth embodiment should be the location information of the radio communications device 30. However, if the radio communications device 30 does not provide its location information, the target should be the information of the location of the base station 81.

The operative steps of the sixth embodiment is outlined hereinafter. When started, it enters Step C11 to receive the information from the radio communication device 30. Step C11 includes the sub-step of C2of receiving the service item request, and the sub-step of C4-1 of receiving the location information of the radio communication device 30. The control center 10 may receive or may not receive the location information of the radio communication device 30 subject to the architecture of the radio communication device 30, and therefore the sub-step of C4-1 may be eliminated. After Step C11, it enters Step C12 to judge if the information of the location of the radio communication device 30 has been received. i.e., Does Step C11 include Step C4-1? Or the received location information of the radio communication device 30 is an error even if Step C4-1 is included in Step C11. And then, it enters step C13 if the information of the location of the radio communication device 30 has been received, or step C14 if not. Once step C13 is entered, it sets the target to be the location of the radio communication device 30, and then enters Step C16. Once step C14 is entered, same as the aforesaid Step C3, it requests the base station 81 to transfer its location or code number information, and then it enters step C15 to set the target to be the location of the base station 81, and then it proceeds to Step C16. Once step C16 is entered, it proceeds the aforesaid Step C5 or Step C5-1 to use facility location information database 20 to search the desired facility information subject to the requested service item and requested information of the location of the destination, and then enters Step C17, same as the aforesaid Step C6, to transfer found facility information to the radio communication device 30.

The sixth embodiment is to set the target to be the location of the radio communication device 30, so that the control center 10 sets the target to be the location of the radio communication device 30 when information of the location of the radio communication device and the information of the location of the base station 81 is received.

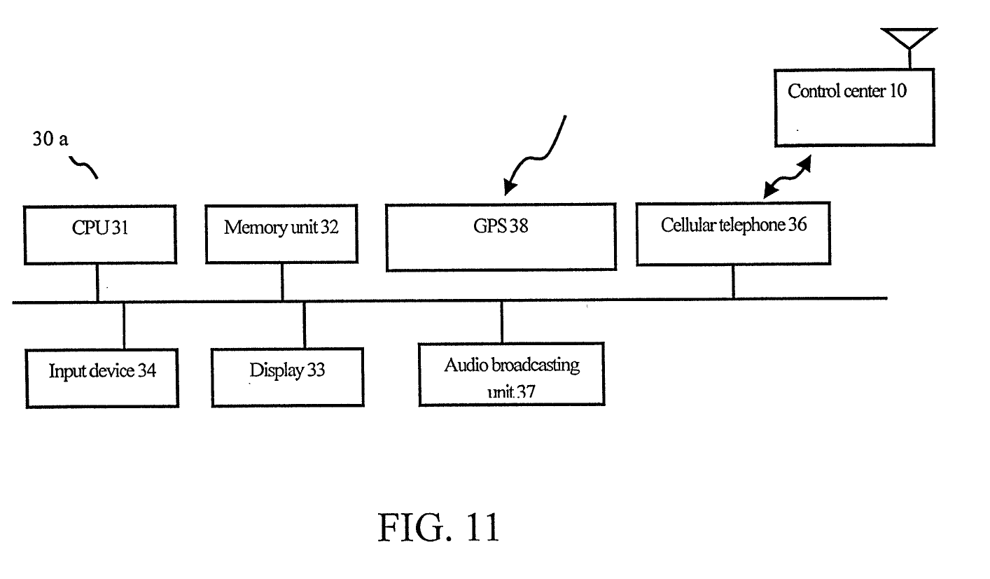

FIG. 11 is a system block diagram of an alternate form of the radio communication device. According to this embodiment, the radio communication device 30a is installed in a motor vehicle. In this case, the radio communication device 30a can be an electronic apparatus of the motor vehicle, comprising a CPU 31, a memory unit 32, a display 33, an input device 34, a cellular telephone 36, an audio broadcasting device 37, and a GPS 38. The radio communication device 30a is connected to the control center 10 through the cellular telephone 36. Because the radio communication device 30a is equipped with a GPS 38, the memory unit 32 is preferably provided with an electronic map (that can be a card based memory or built-in memory, or downloaded from the Internet through the cellular telephone 36). When the desired facility message is obtained from the control center 10, the facility can be marked on the electronic map. Further, the cellular telephone 36 can be constructed to function as a radio communication device 30 for use with another equipment of the motor vehicle.

Although the present invention has been explained in relation to its preferred embodiments, it is to be understood that many other possible modifications and variations can be made without departing from the spirit and scope of the invention as hereinafter claimed. For example, the control center 10 can be constructed to connect to the Internet by radio without through the aforesaid PSTN 80. In case the control center 10 provides one particular service only (for example, parking lot information), the aforesaid Step A2 and Step C2 are eliminated, and the columns for facility code number 21 and facility type 22 are eliminated from the facility information database 20. The control center 10 can also be set to provide a respective telephone number for a respective service offered, for example, calling the telephone number XXX1 is to request parking lot information, or calling the telephone number XXX3 is to request police station information. In this case, the aforesaid Step A2 and Step C2 are eliminated.

What is claimed is:

1. A method of transferring facility information by radio in which the user uses a radio communication device to connect to a control center through a base station, requesting the control center to transfer the facility information in the area around the location of the radio communication device, the method comprising the steps of:
(a) receiving a connection request from said radio communication device for enabling said radio communication device to be connected to said control center;
(b) obtaining a target, said target including at least the information of the location of said base station and the information of the location of said radio communication device;
(c) searching a facility information database for the desired facility information subject to said target, said facility information database comprising the names of multiple facilities and the information of the locations of said multiple facilities; and
(d) transferring found facility information to said radio communication device.

2. The method of transferring facility information by radio as claimed in claim 1, wherein said target is the information of the location of said base station provided by said base station under the request of said control center.

3. The method of transferring facility information by radio as claimed in claim 1, wherein said target is the information of the location of said base station actively provided by said base station to said control center.

4. The method of transferring facility information by radio as claimed in claim 1, wherein said target is the information of the location of said radio communication device actively provided by said radio communication device to said control center.

5. The method of transferring facility information by radio as claimed in claim 1 further comprising a step for receiving the service item request from said radio communication device so that the searching step (c) uses said target and said service item for searching the desired facility information.

6. The method of transferring facility information by radio as claimed in claim 1, wherein said radio communication device is a cellular telephone.

7. The method of transferring facility information by radio as claimed in claim 1, wherein said radio communication device is installed in a car.

8. The method of transferring facility information by radio as claimed in claim 1, wherein the target is set to be the location of said radio communication device during the step of (b) once said control center obtained the information of the location of said radio communication device.

9. A control center using a method of transferring facility information by radio in which the user uses a radio communication device to connect to a control center through a base station, requesting the control center to transfer the information of facilities in the area around the location of the radio communication device, the control center comprising:
a communication system adapted to receive messages from the outside, or to transmit messages to the outside; and
a computer system connected to said communication system, said computer system comprising a facility information database;
said communication system and said computer system enabling said control center to achieve the following functions:
(a) receiving a connection request from said radio communication device for enabling connection between said radio communication device and said control center;
(b) obtaining a target, said target including at least a part of the information of the location of said base station and the information of the location of said radio communication device;
(c) searching a facility information database for the desired facility information subject to said target, said facility information database comprising the names of multiple facilities and the information of the locations of said multiple facilities; and
(d) transferring found facility information to said radio communication device.

10. The control center as claimed in claim 9, wherein said target is the information of the location of said base station provided by said base station under the request of said control center.

11. The control center as claimed in claim 9, wherein said target is the information of the location of said base station actively provided by said base station to said control center.

12. The control center as claimed in claim 9, wherein said target is the information of the location of said radio communication device actively provided by said radio communication device to said control center.

13. The control center as claimed in claim 9 further comprising a function for receiving the request for service item from said radio communication device so that the searching function (c) uses said target and said service item for searching the desired facility information.

14. The control center as claimed in claim 9, wherein said radio communication device is a cellular telephone.

15. The control center as claimed in claim 9, wherein said radio communication device is installed in a car.

16. The control center as claimed in claim 9, wherein the target is set to be the location of said radio communication device in function (b) once said control center obtains the information of the location of said radio communication device.
